(19) United States
(12) Patent Application Publication
(10) Pub. No.: US 2008/0193701 A1
(43) Pub. Date: Aug. 14, 2008

(54) OPTICAL FILM PRODUCTS AND METHOD FOR PRODUCING OPTICAL FILM PRODUCTS

(75) Inventors: Toshimitsu TAKAYANAGI, Osaka (JP); Noriyuki MIYAHARA, Osaka (JP); Hiroyuki TAKAHASHI, Osaka (JP); Hiroyuki NATSUME, Osaka (JP); Takafumi IMAI, Osaka (JP); Yoshihiro TODA, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Osaka (JP)

(21) Appl. No.: 12/026,891

(22) Filed: Feb. 6, 2008

(30) Foreign Application Priority Data
Feb. 8, 2007 (JP) 2007-029437

(51) Int. Cl. G02B 5/00; B29D 11/00

(52) U.S. Cl. 428/64.4; 264/1.34

(57) ABSTRACT

An object of the invention is to provide an optical film product that is configured such that the direction of an optical axis can be easily recognized and that markings do not interfere with a defect inspection and to provide a method for producing such an optical film product.

The invention is directed to an optical film product, including: an optical film layer having an optical axis; a surface protection film that is laminated on the optical film layer to protect the surface of the optical film layer; and an optical axis information part that shows information about the optical axis and is interposed between the optical film layer and the surface protection film.

### BACKGROUND OF THE INVENTION

1. Field of the Invention

The present invention relates to an optical film product including an optical film layer having an optical axis and a surface protection film that is laminated on the optical film layer to protect the surface of the optical film layer. The invention also relates to methods for producing the optical film products.

2. Description of the Related Art

A known conventional film product includes an optical layer having an optical axis and a surface protection film that is laminated on the optical film layer to protect the surface of the optical film layer. Examples of the optical film layer include a polarizing plate for use in liquid crystal displays, a retardation plate, a laminate of a polarizing plate and a retardation plate, and so on. The surface protection film is provided to protect the surface of the optical film layer and attached to the surface of the optical film layer with a pressure-sensitive adhesive or the like in such a manner that it can be separated when incorporated into a liquid crystal display or the like.

In some cases, a film layer, called separator, is attached to the other surface of the optical film layer opposite to the surface protection film. The separator is also provided to protect the surface of the optical film layer and to protect a pressure-sensitive adhesive layer for fixation to liquid crystal displays. The pressure-sensitive adhesive layer is held on the surface of the optical film layer, even after the separator is peeled off.

The optical film has an optical axis. For example, one optical axis is formed parallel to the stretch direction in the optical film. If the direction of the optical axis is misaligned in a liquid crystal display, the liquid crystal display will not work. Therefore, the direction of the optical axis is marked by stamping or any other technique on the surface of the surface protection film for the optical film layer so that the axis direction can easily be identified. However, the marking by stamping or the like is performed by hand and thus very poor in work efficiency. Particularly when a release layer such as a silicon layer is formed on the surface protection film, it is necessary to wipe the release layer off with alcohol or the like so that the work efficiency can be further reduced. In addition, since stamp ink is slow to dry, it is also necessary to place a paper cover on the film after the stamping, which is economically disadvantageous.

Japanese Patent Application Laid-Open (JP-A) No. 2003-14934 discloses a method for forming a mark indicating an optical axis direction on a surface protection film to facilitate recognition of the optical axis direction. The method disclosed in JP-A No. 2003-14934 includes printing the optical axis direction on the surface protection film with an inkjet machine in place of stamping by hand.

There is known an optical film for use in liquid crystal displays that includes a surface protection film and a reference mark (for identifying an optical axis or the like) formed with a UV paint on the surface protection film (see JP-A No. 10-221685). According to JP-A No. 10-221685, the reference mark is formed with a UV paint in such a manner that the reference mark does not interfere with an inspection during a quality inspection of a polarizing film under visible light or during a quality inspection of liquid crystal display devices each having polarizing films placed on a liquid crystal cell. It is also disclosed that when the optical axis direction is checked, the UV paint is illuminated by black light irradiation so that visual recognition of the reference mark can be ensured.

### SUMMARY OF THE INVENTION

According to JP-A No. 2003-14934, a protection film-attached polarizing plate of a given size fed from the upstream process is detected by a sensor. Based on the detection result, in the next process, the feeding of the protection film-attached polarizing plate is stopped, when marking is performed on the surface of the protection film with an inkjet machine, so that the marking place is limited within the inkjet printing range. A plurality of marking places provided for easy recognition of the optical axis direction are not preferred in terms of long printing time and production efficiency. On the other hand, use of a plurality of inkjet machines is not preferred in terms of equipment cost and installation area.

This technique is intended for the marking of specifically-sized cut pieces of protection film-attached polarizing plate and not intended for the marking of a long raw material for protection film-attached polarizing plates (for example, a roll of a raw material with a length of several tens of meters or more). Direct use of the technique of JP-A No. 2003-14934 in marking the optical axis direction on a roll of a raw material is not preferred in terms of production efficiency and manufacturing cost.

According to JP-A No. 10-221685, a UV paint is used for marking. When printing is performed on the surface protection film, dried triangle markings as shown in FIG. 3 become white or opaque like ground glass under visible light (indicated by slanted lines in FIG. 3) and easily visible. Such markings do not interfere with an inspection of relatively large defects (such as scratches, foams and foreign matters). For example, however, recent high-precision high-quality demands require an inspection of defects in the range of 80 μm to 150 μm, so that the whitening of the UV paint can interfere with such a defect inspection. Therefore, improvements are strongly required. Even when a transparent UV paint is used for printing on the surface protection film, the markings also become white and easily visible so that defects overlapping with the markings in the vertical direction cannot surely be detected.

The invention has been made in light of the circumstances described above, and an object of the invention is to provide an optical film product that is configured such that the direction of an optical axis can be easily recognized and that markings do not interfere with a defect inspection and to provide a method for producing such an optical film product.

As a result of investigations for solving the problems, the invention described below has been completed. Specifically, the invention is directed to an optical film product, including: an optical film layer having an optical axis; a surface protection film that is laminated on the optical film layer to protect the surface of the optical film layer; and an optical axis information part that shows information about the optical axis is interposed between the optical film layer and the surface protection film.

The features of the invention bring about the advantageous effects described below. The optical film product includes: an optical film layer having an optical axis; a surface protection film that is laminated on the optical film layer to protect the surface of the optical film layer; and an optical axis information part that shows information about the optical axis is interposed between the optical film layer and the surface protection film. The optical axis information part is preferably printed on the surface protection film side. This is because the surface protection film is separated from the optical film layer, for example, when the surface protection film is installed in a liquid crystal display, and if the optical axis information part remains on the optical film layer in such a case, the display cannot work. Specifically, the optical axis information part printed on the surface protection film is interposed between the surface protection film and the optical film layer through a pressure-sensitive adhesive, so that the optical axis information-forming part is surrounded by the pressure-sensitive adhesive layer and visible to such an extent that defect inspections are not interfered with when the appearance is visually examined. Therefore, even when the optical axis information part is formed using a transparent paint, a fluorescent paint, a UV paint, or the like, the optical information can be recognized, and defect inspections can be performed with high precision with no interference from the optical axis information.

The optical film product may be a cut piece of a given size or form a long material. The optical film having an optical axis may be a polarizing plate, a retardation plate or a composite thereof. The polarizing plate may be provided with a protection layer (film) for protecting the polarizing plate. As used herein, the term “defect” means a defect unfavorable for products, and examples of such a defect include foreign matters, dirt, scratches, knicks, and foams on the surface of the optical film or in the optical film.

In a preferred embodiment of the invention, the optical axis information part is formed on the surface protection film by printing with a fluorescent material-containing paint, so that the optical axis information part can be easily recognized using ultraviolet light (black light). The fluorescent material is any material that can emit light upon ultraviolet irradiation and may be an inorganic or organic material. The fluorescent material-containing paint is preferably transparent. For example, polymethacrylate ester, a vinyl resin, an alkyd resin, or the like may be used as the resin for the fluorescent material-containing paint.

In another aspect, the invention is directed to a method for producing an optical film product including an optical film layer having an optical axis and a surface protection film that is laminated on the optical film layer to protect the surface of the optical film layer, including the steps of: printing optical axis information part about the optical axis on the surface protection film; and attaching the optical film layer and the surface protection film with the printed optical axis information part, while interposing the optical axis information part between the surface protection film and the optical film layer.

The features of the method of the invention bring about the advantageous effects described below. The production method according to the invention includes the steps of: printing optical axis information about the optical axis on the surface protection film; and attaching the optical film layer and the surface protection film with the printed optical axis information part, while interposing the optical axis information part between the surface protection film and the optical film layer. Thus, the optical axis information part can be previously printed on the surface protection film so that work efficiency can be significantly increased, in contrast to conventional techniques in which work efficiency is very low, because an optical axis information part is formed using a stamp, an inkjet machine or the like on the surface protection film after an optical film product is prepared. According to the invention, the optical axis information part can be previously printed on the surface protection film, and, therefore, the method is particularly advantageous for the production of a long optical film product. If a continuous printing method (such as a continuous printing method using a printing plate in the form of a roll) is used for the printing, the printing speed can be increased, while the manufacturing cost can be reduced. Artificial mistakes caused by stamping can also be avoided. The optical film product produced by the production method of the invention brings about the same advantageous effects as the optical film product described above does.

In a preferred embodiment of the production method, the optical axis information part is printed with a fluorescent material-containing paint on the surface protection film, so that the same advantageous effect as described above can be produced.

### BRIEF DESCRIPTION OF THE DRAWINGS

FIG. 1 is a diagram illustrating an optical film product;

FIG. 2 is a diagram illustrating embodiments of the optical axis information; and

FIG. 3 is a diagram illustrating markings formed on a conventional optical film product.

### DETAILED DESCRIPTION OF THE PREFERRED EMBODIMENTS

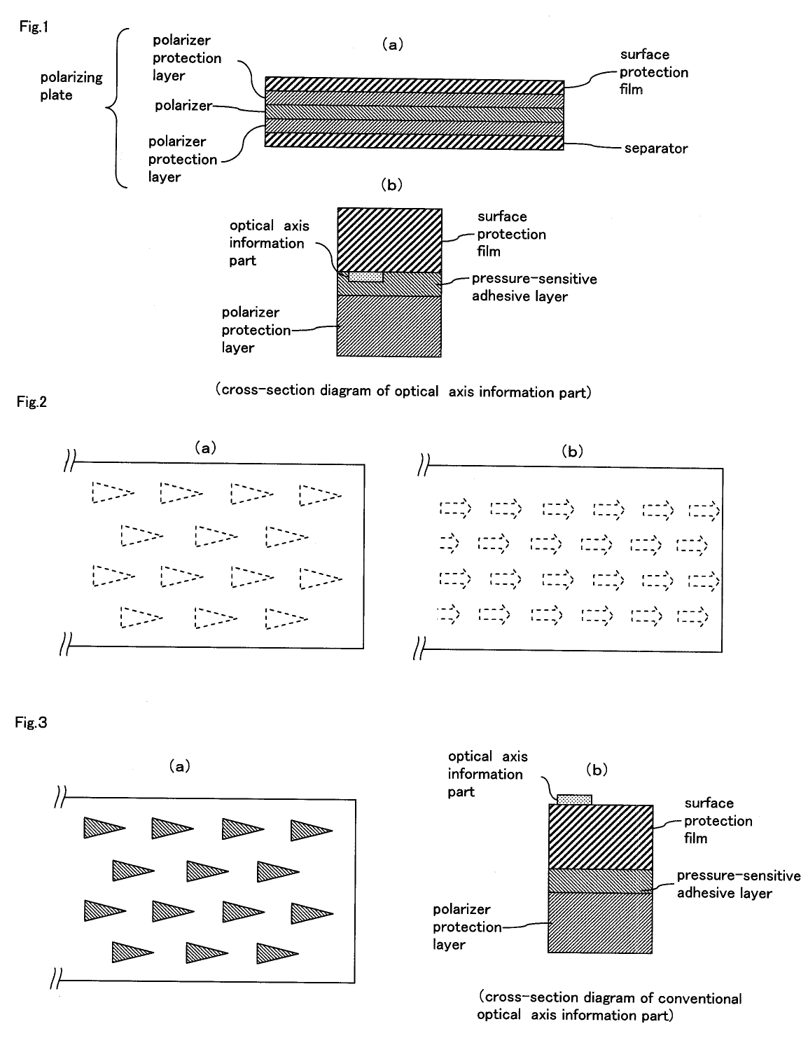

Preferred embodiments of the invention are described below with reference to the drawings. FIG. 1 shows an exemplary optical film. FIG. 2 shows embodiments of the optical axis information.

### Optical Film Product

For example, the optical film layer is made of a polarizing plate having an optical axis, a retardation plate having an optical axis, or a laminate of these plates. The optical film product shown in FIG. 1 includes: a polarizing plate including a polarizer and a polarizer protection layer formed on both sides of the polarizer; a surface protection film placed on one side of the polarizing plate; and a separator placed on the other side of the polarizing plate.

The surface protection film includes a base film made of a plastic film and having a weak pressure-sensitive adhesive layer releasably attached to the surface of the polarizing plate.

For example, but not limited to, a biaxially-stretched film of polypropylene, polyester or the like is preferably used as the base film for the surface protection film. The thickness of the base film is preferably, but not limited to, from about 10 to about 200 μm.

Any pressure-sensitive adhesive may be used to form a pressure-sensitive adhesive layer that is interposed between the surface protection film and the polarizer protection layer. For example, any of acrylic, synthetic rubber-based, and rubber-based pressure-sensitive adhesives may be used to form the pressure-sensitive adhesive layer. In particular, the acrylic pressure-sensitive adhesive is preferred, because its adhesive strength can be easily controlled by changing its composition. If necessary, the pressure-sensitive adhesive may appropriately contain a crosslinking agent, a tackifier, a plasticizer, a filler, an antioxidant, an ultraviolet absorbing agent, a silane coupling agent, or the like. The pressure-sensitive adhesive may be formed by subjecting the surface protection film or the polarizing plate to a transfer method, a direct print method, a co-extrusion method, or the like. The thickness (dry thickness) of the pressure-sensitive adhesive layer is generally, but not limited to, about 5 to about 50 μm.

An adhesive containing a vinyl alcohol polymer or an adhesive containing at least a vinyl alcohol polymer and a water-soluble crosslinking agent for the polymer, such as boric acid, borax, glutaraldehyde, melamine, or oxalic acid may be used to form an adhesive layer that is interposed between the polarizer and the polarizer protection layer. Such an adhesive layer may be formed by applying an aqueous adhesive solution and drying it, and if necessary, any other additive or a catalyst such as an acid may be added to form the aqueous solution.

The polarizing plate generally has the structure shown in FIG. 1, in which a polarizer protection layer is placed on both sides of a polarizer. One side of the polarizer protection layer may be provided with a pressure-sensitive adhesive layer that is used to attach the polarizing plate to a glass substrate of a liquid crystal display, and a separator may be further provided to protect the pressure-sensitive adhesive layer.

Various types of polarizer may be used without limitation. Examples of the polarizer include products manufactured by a process including the steps of adsorbing a dichroic material such as iodine or a dichroic dye on a hydrophilic polymer film such as a polyvinyl alcohol film, a partially formalized polyvinyl alcohol film, or a partially saponified ethylene-vinyl acetate copolymer film and stretching the film; and oriented polyene films such as products produced by dehydrating polyvinyl alcohol and products produced by dehydrochlorination of polyvinyl chloride. The thickness of the polarizer is generally, but not limited to, from about 5 to about 80 μm. The thickness of the polarizer may be controlled using any general method such as tentering, roll stretching, and rolling.

In particular, products manufactured by stretching a polyvinyl alcohol film, adsorbing a dichroic material (such as iodine or a dye) thereon and orienting the dichroic material are preferably used. The processes of dyeing, crosslinking and stretching the polyvinyl alcohol film are not necessarily performed independently and may be performed at the same time or in any order. The polyvinyl alcohol film may also undergo a swelling process before use. A general method includes immersing a polyvinyl alcohol film in a solution containing iodine or a dichroic dye to adsorb the iodine or dichroic dye thereon, then washing the film and uniaxially stretching the film to a stretch ratio of 3 to 7 in a solution containing boric acid, borax or the like, and then drying the film. It is particularly preferred that stretching the film in a solution containing iodine or a dichroic dye should be followed by stretching (biaxially stretching) the film in a solution contain boric acid, borax or the like and then drying the film, because the iodine can be highly oriented to produce good polarization degree characteristics.

Examples of the above-described polyvinyl-alcohol-based polymer are those obtained by polymerizing vinyl acetate and then performing saponization, those obtained by copolymerizing a small amount of polymerizable polymers such as unsaturated carboxylic acid, unsaturated sulfonic acid, and cationic monomers with vinyl acetate, and the like. The average polymerization degree of the polyvinyl-alcohol-based polymer is not particularly limited, so that those having an arbitrary polymerization degree can be used; however, the polymerization degree is preferable 1000 or higher, more preferably 2000 to 5000. Also, the saponization degree of the polyvinyl-alcohol-based polymer is preferably 85 mol % or higher, more preferably 98 to 100 mol %.

As the polarizer protective layer disposed on one side or on both sides of the polarizer, a suitable transparent film can be used. Among these, a film made of a polymer being excellent in transparency, mechanical strength, thermal stability, water-shielding property, and the like is preferably used. Examples of the polymer are acetate-based resin such as triacetylcellulose, polycarbonate-based resin, polyester-based resin such as polyallylate or polyethylene terephthalate, polyimide-based resin, polysulfone-based resin, polyethersulfone-based resin, polystyrene-based resin, polyolefin-based resin such as polyethylene or polypropylene, polyvinylalcohol-based resin, polyvinyl-chloride-based resin, polynorbornene-based resin, polymethyl-methacrylate-based resin, liquid crystal polymer, and the like. The film may be produced by any of the casting method, the calendaring method, and the extrusion method.

Also, another example of the film is a polymer film disclosed in Japanese Patent Application Laid-Open (JP-A) No. 2001-343529 (WO01/37007), for example, a resin composition containing (A) a thermoplastic resin having a substituted and/or non-substituted imide group in a side chain and (B) a thermoplastic resin having substituted and/or non-substituted phenyl and nitrile groups in a side chain. A specific example is a film made of a resin composition containing an alternate copolymer of isobutyrene and N-methylmaleimide and an acrylonitrile/styrene copolymer. As the film, a film made of a mixed and extruded product of the resin composition can be used. Since these films have only a small retardation and a small optical elastic modulus, inconveniences such as unevenness caused by the distortion of the polarizing plate can be eliminated. Also, since the humidity transmitting degree is small, the film is excellent in the durability against addition of moisture.

Also, the polarizer protective layer is preferably colored as little as possible. Therefore, a protective film in which the retardation value in the film thickness direction represented by Rth=[(nx+ny)/2−nz]·d (where nx and ny are principal refractive indices within the film plane; nz is a refractive index in a film thickness direction; and d is the film thickness) is −90 nm to +75 nm is preferably used. By using such a film in which the retardation value (Rth) in the thickness direction is −90 nm to +75 nm, the coloring (optical coloring) of the polarizing plate caused by the protective film can be almost completely eliminated. The retardation value (Rth) in the thickness direction is more preferably −80 nm to +60 nm, most preferably −70 nm to +45 nm.

In view of the polarization characteristics, the durability, and the like, an acetate-based resin such as triacetylcellulose is preferable, and in particular a triacetylcellulose film whose surface has been subjected to saponization process with an alkali is preferable.

The thickness of the polarizer protective layer is arbitrary; however, typically the thickness is 500 μm or below, preferably 1 to 300 μm, more preferably 5 to 200 μm, for the purpose of thickness reduction of the polarizing plate. Here, in the event that the polarizer protective layer made of a transparent film is disposed on both surfaces of the polarizing film, transparent films made of different polymers or the like may be used on the front and rear surfaces.

The polarizer protective layer may be subjected to a hard-coating process, an antireflection process, processes performed for the purposes of preventing or diffusing sticking, or antiglaring. The hard-coating process is carried out for the purpose of preventing scars to be formed on the polarizing plate surface, and the hard-coating can be formed by adding a cured skin film being excellent in hardness or slipping property made by an ultraviolet-curing resin such as a silicone-based one onto the surface of the transparent protective film.

On the other hand, the antireflection process is carried out for the purpose of preventing reflection of external light on the polarizing plate surface, and can be achieved by forming an antireflection film according to the prior art. Also, the sticking preventing process is performed for the purpose of preventing close adhesion to adjacent layers, and the antiglaring process is carried out for the purpose of preventing hindrance of the visibility of the light transmitted through the polarizing plate caused by reflection of external light on the surface of the polarizing plate, and can be formed, for example, by imparting a fine undulation structure on the surface of the transparent protective film by a suitable method such as the surface roughening treatment by the sandblast method or the emboss processing method, or the method of blending transparent fine particles.

The above-described transparent fine particles may be, for example, silica, alumina, titanium, zirconia, tin oxide, indium oxide, cadmium oxide, antimony oxide, or the like having an average particle size of 0.5 to 20 μm. Inorganic fine particles having an electric conductivity may be used, and organic fine particles made of crosslinked or non-crosslinked polymer particulate substances may be used. The amount of using the transparent fine particles is typically 2 to 70 parts by mass, preferably 5 to 50 parts by mass, relative to 100 parts by mass of the transparent resin.

Further, the antiglaring layer blended with the transparent fine particles can be provided as the transparent protective layer itself or as a layer applied onto the surface of the transparent protective layer. The antiglaring layer may also serve as a diffusing layer for enlarging the viewing angle (viewing angle compensating function) by diffusing the light transmitted through the polarizing plate. Here, the antireflection layer, the sticking preventing layer, the diffusing layer, the antiglaring layer, and the like described above may be provided separately from the transparent protective layer as optical layers made of sheets on which those layers are disposed.

Various types of pressure-sensitive adhesives such as acrylic, synthetic rubber-base, and rubber-based pressure-sensitive adhesives may be used to form the pressure-sensitive adhesive layer that is interposed between the separator and the polarizer protection layer. Examples of materials for the separator include paper and films of synthetic resin such as polyethylene, polypropylene and polyethylene terephthalate. If necessary, the surface of the separator may be subjected to release treatment such as silicone treatment, long-chain alkyl treatment, and fluorine treatment in order to increase the releasability from the pressure-sensitive adhesive layer.

### Optical Axis Information

The optical axis information according to the invention may be any type of information about the optical axis of the optical film, as long as the optical axis orientation can be identified based on it. As illustrated in FIG. 2, the optical axis information part may be a triangle (in which the direction of the more acute angle indicates the optical axis direction), an arrow (whose direction indicates the optical axis direction) or any other figure, picture, letter, or the like. In FIG. 2, the triangle and the arrow are shown by dotted lines for the sake of illustration. Practically, however, the optical axis information part is not visually a dotted line but is visually recognized from the outside to such an extent that a defect inspection with high precision (for example, an inspection for detecting 80 μm to 150 μm defects) is not interfered with.

The optical axis information part may be formed at given positions or at random over the whole of the optical film product. The position where the optical axis information part is formed may be determined as necessary depending on the manufacturer's or user's specification. A long optical film product may be cut into final products of a specific size. In such a case, optical axis information parts are preferably formed over the whole of the optical film product such that every cut piece can have the optical axis information part.

The optical axis information part is formed such that it is interposed between the surface protection film and the polarizer protection layer (or the polarizing plate). A pressure-sensitive adhesive layer is then formed on the surface protection film having the optical axis information part. The optical axis information-forming part is covered with the pressure-sensitive adhesive layer so that the step formed at the interface (boundary) of the part can be inconspicuous and that the whole of the part can be transparent. Thus, the optical axis information part is visible from the outside to such an extent that defect inspection with high precision (for example, inspection for detecting 80 μm to 150 μm defects) is not interfered with.

A transparent paint or a fluorescent material-containing paint is preferably used to form the optical axis information part on the surface protection film. The fluorescent material-containing paint is particularly preferred, because the optical axis information part formed with it is surely and easily visible by black light irradiation. While any known transparent paint or fluorescent material-containing paint may be used, it is preferred that more appropriate paint should be selected in terms of durability to the pressure-sensitive adhesive.

Examples of methods for forming the optical axis information part on the surface protection film include, but not limited to, stamping methods, inkjet methods, transfer methods, spray methods, and printing methods. Examples of printing methods include letterpress printing methods, gravure printing methods and screen printing methods. In particular, letterpress printing methods or gravure printing methods are preferred, because they allow continuous printing.

The optical axis information part is preferably formed thinner than the pressure-sensitive adhesive layer. For example, the thickness of the optical axis information part is preferably from 0.1% to 10% of the thickness of the pressure-sensitive adhesive layer. For example, when the average thickness of the pressure-sensitive adhesive layer is set at 6 μm, the average thickness of the optical axis information-forming part may be set in the range of 0.006 μm to 0.6 μm. If the thickness of the optical axis information-forming part is set in the range of 0.1% to 10% of that of the pressure-sensitive adhesive layer, the optical axis information-forming part can be surely covered with the pressure-sensitive adhesive.

### Production Method

An example of the method for producing a long optical film product according to the invention is described below. (A) First, in the process of preparing a polarizer, a polyvinyl alcohol (PVA) film is subjected to dyeing, crosslinking and stretching and then dried to give a polarizer. In this process, the stretching direction coincides with the optical axis direction. (B) In the process of preparing a polarizing plate, a triacetylcellulose (TAC) film is bonded to both sides of the polarizer with an adhesive interposed therebetween to form a polarizer protection layer thereon so that a polarizing plate is produced. In the drawings, the TAC film to be laminated thereon has previously undergone antiglare treatment.

(C) A surface protection film is produced in a production line (or place) different from that for the process of preparing the polarizing plate. While a raw film for surface protection is unwound and fed, an optical axis information part is continuously formed with a fluorescent material-containing paint or a transparent paint on one side of the raw film, for example, by a letterpress printing method. A release film (or paper) having a weak pressure-sensitive adhesive layer is then attached to the surface protection film. In this process, the optical axis information part and the weak pressure-sensitive adhesive layer are interposed between the release film and the surface protection film attached thereto, and the films are wound into a roll.

(D) The process of attaching the surface protection film. The surface protection film is attached to one side (upper side in FIG. 1) of the polarizing plate with the weak pressure-sensitive adhesive interposed therebetween. The surface protection film has the optical axis information part formed by printing and is coated with the weak pressure-sensitive adhesive. The surface protection film is attached to the polarizing plate, while the release film is separated from the surface protection film. Even when the surface protection film is separated from the release film, the weak pressure-sensitive adhesive coating and the printed optical axis information part still remain on the surface protection film and are substantially not transferred to the TAC film.

(E) The process of attaching a separator. A separator is attached to one side (lower side in FIG. 1) of the polarizing plate with a strong pressure-sensitive adhesive interposed therebetween. The separator has been previously coated with the strong pressure-sensitive adhesive. The strong pressure-sensitive adhesive coating on the separator is transferred to the TAC film, after the separator is peeled off. The processes (D) and (E) may be performed at the same time, or the process (E) may be performed before the process (D).

After the above processes, a long optical film product is obtained. After the attaching process (D and E), the long optical film may be cut into optical film products of a specific size, or the long optical film product may be wound into a roll and then cut into pieces of a specific size in any other process.

According to the production method described above, long optical film products can be efficiently produced, and significant advantages such as a significant improvement in work efficiency, a reduction in manufacturing facility cost and a reduction in human error can be produced in contrast to conventional production methods.

### OTHER EMBODIMENTS

In practical use, the optical film product according to the present invention, an example is a method of performing a hard-coating process, an antireflection process, surface treatments performed for the purposes of preventing sticking, diffusing, or antiglaring, or laminating a oriented liquid crystal layer for the purpose of viewing angle compensation or the like. Also, examples of the optical layer are those obtained by bonding one layer or two or more layers of an optical film used for forming a liquid crystal display device such as a reflection plate, a semitransparent plate, a retardation plate (including a wavelength plate (plate) such as ½ or ¼), or a viewing angle compensating film. In particular, when the sheet-shaped product is a polarizing plate, it can be preferably applied as a reflection-type polarizing plate or a semi-transmitting type polarizing plate made by lamination of a reflecting plate or a semitransmitting plate, an elliptic or circular polarizing plate made by lamination of a retardation plate, a wide viewing angle plate made by lamination of a viewing angle compensating layer or a viewing angle compensating film, or a polarizing plate made by lamination of a brightness-improving film.

The reflection type polarizing plate is one in which a reflection layer is provided in a polarizing plate, and is used for forming a liquid crystal display device of a type that displays by reflecting incident light coming from the visible side (display side), and has advantages such as facilitated thickness reduction of the liquid crystal display device because incorporation of a light source such as back light can be omitted. The reflection-type polarizing plate can be formed, for example, by a suitable method such as additionally disposing a reflection layer made of metal or the like on one surface of a polarizing plate via a transparent protective layer in accordance with the needs.

A specific example of a reflection-type polarizing plate is a plate in which a reflection layer is formed by additionally disposing a foil or a vapor-deposited film made of a reflective metal such as aluminum on one surface of a transparent protective film subjected to a matting process in accordance with the needs. Also, another example is a plate having a surface fine undulating structure obtained by allowing fine particles to be contained in the above-described transparent protective film and further having a reflection layer of fine undulating structure thereon. The above-described reflection layer of fine undulating structure has advantages of preventing directivity or glittering appearance by diffusing the incident light by random reflection and restraining unevenness of brightness and darkness. Also, the transparent protective film containing fine particles has advantages of further restraining the unevenness of brightness and darkness because the incident light and the reflected light thereof are diffused when passing through the film. The reflection layer having a fine undulating structure on which the surface fine undulating structure of the transparent protective film is reflected can be formed, for example, by directly adding metal to the surface of the transparent protective layer by a suitable method such as a vapor deposition method such as the vacuum vapor deposition method, ion plating method, or the sputtering method, or the plating method.

The reflection plate can also be used as a reflection sheet in which a reflection layer is disposed on a suitable film that accords to the transparent film in place of directly imparting to the transparent film (polarizer protective film) of the above-described polarizing plate. Herein, since the reflection layer is typically made of metal, the usage mode in a state in which the reflection surface thereof is covered with a transparent film or a polarizing plate is preferable in view of preventing decrease in the reflectivity caused by oxidation, and further the long-term durability of the initial reflectivity, and the avoidance of separately disposing a protective layer.

Herein, the semitransmitting polarizing plate can be obtained by making a reflection layer of semitransmittance type such as a half mirror that reflects and transmits light at the reflection layer in the above construction. The semitransmittance type polarizing plate is typically disposed on the back surface of a liquid crystal cell, and can form a liquid crystal display device or the like of a type such that, in the event that a liquid crystal display device or the like is used in a comparatively bright atmosphere, images are displayed by reflecting the incident light coming from the visible side (display side) and, in a comparatively dark atmosphere, images are displayed by using an incorporated light source such as a back light unit that is incorporated on the back side of the semitransmitting type polarizing plate. Namely, the semitransmitting type polarizing plate is useful for forming a liquid crystal display device of a type that can save the energy of using the light source such as a back light unit in a bright atmosphere and can be used by using an incorporated light source even in a comparatively dark atmosphere.

The elliptic polarizing plate or the circular polarizing plate made by further laminating a retardation plate on a polarizing plate will be described. A retardation plate or the like is used in the case of converting linearly polarized light into elliptically polarized light or circularly polarized light, converting elliptically polarized light or circularly polarized light into linearly polarized light, or changing the polarization direction of linearly polarized light. In particular, as a retardation plate that converts linearly polarized light into circularly polarized light or converts circularly polarized light into linearly polarized light, a so-called ¼ wavelength plate (also referred to as λ/4 plate) is used. A ½ wavelength plate (also referred to as λ/2 plate) is used typically for changing the polarization direction of linearly polarized light.

The elliptic polarizing plate is effectively used for compensating (preventing) the coloring (blue or yellow) generated by birefringence of the liquid crystal layer of a super twist nematic (STN) type liquid crystal display device, so as to perform white and black display without the above-described coloring. Further, those that control the three-dimensional refractive index can compensate (prevent) the coloring generated when the screen of the liquid crystal display device is viewed in an oblique direction, so that it is preferable. The circular polarizing plate is effectively used, for example, for regulating the color tone of the images of the reflection-type liquid crystal display device in which the images are displayed in color, and also has a function of preventing reflection.

Another example of optical film layer is a retardation. As the retardation plate, a birefringent film obtained by monoaxial or biaxial stretching of a polymer material, an oriented film of liquid crystal polymer, one in which the oriented layer of liquid crystal polymer is supported by a film, and the like. The stretching process can be carried out, for example, by roll stretching method, long gap stretching method, tenter stretching method, tubular stretching method, or the like. The magnification of stretching is typically about 1.1 to 3 times in the case of monoaxial stretching. The thickness of the retardation plate is not particularly limited; however, the thickness is typically 10 to 200 μm, preferably 20 to 100 μm.

Examples of the above-described polymer material are polyvinyl alcohol, polyvinyl butyral, polymethyl vinyl ether, polyhydroxyethyl acrylate, hydroxyethylcellulose, hydroxypropylcellulose, methylcellulose, polycarbonate, polyallylate, polysulfone, polyethylene terephthalate, polyethylene naphthalate, polyethersulfone, polyphenylene sulfide, polyphenylene oxide, polyallylsulfone, polyvinyl alcohol, polyamide, polyimide, polyolefin, polyvinyl chloride, cellulose-based polymer, and various two-element or three-element copolymers, graft copolymers, and blended products of these. These polymer materials are made into an oriented product (stretched film) by stretching or the like.

Examples of the above-described liquid crystal polymer are various polymers of main chain type or side chain type in which a conjugate linear atomic group (mesogen) that imparts liquid crystal orientation property is introduced the main chain or the side chain of the polymer. Specific examples of the liquid crystalline polymer of main chain type are, for instance, a polyester-based liquid crystalline polymer having, for example, a nematic orientation property, a discotic polymer, or a cholesteric polymer having a structure such that the mesogen groups are bonded with a spacer part that imparts a bending property. Specific example of a liquid crystal polymer of side chain type are, for instance, those having polysiloxane, polyacrylate, polymethacrylate, or polymalonate as a main chain skeleton and having a mesogen part made of a para-substituted cyclic compound unit having a nematic orientation imparting property via a spacer part made of a conjugate atomic group as the side chain. These liquid crystalline polymers are carried out, for example, by developing a solution of liquid crystalline polymer on an orientation-processed surface of those obtained by a rubbing treatment, tilted vapor deposition of silicon oxide, or the like of the surface of a thin film such as polyimide or polyvinyl alcohol formed on a glass plate, followed by a thermal treatment.

The retardation plate may be a plate having a suitable retardation in accordance with an intended object of use such as various wavelength plates and those intended for compensation of coloring or viewing angle caused by birefringence of the liquid crystal layer, or may be those in which the optical characteristics such as the retardation are controlled by laminating two or more kinds of retardation plates.

The viewing angle compensating film is a film for enlarging the viewing angle so that the images can be looked at comparatively vividly even in a case in which the screen of the liquid crystal apparatus is looked at not vertically to the screen but in a little oblique direction. Examples of such a viewing angle compensating retardation plate are those in which an oriented layer of liquid crystal polymer or the like is supported on an oriented film or a transparent base material such as a retardation film or a liquid crystal polymer. In a typical retardation plate, a polymer film having birefringence that has been monoaxially stretched in the plane direction thereof is used. However, in a retardation plate used as a viewing angle compensating film, a polymer film having birefringence that has been biaxially stretched in the plane direction or a two-direction stretched film such as a polymer film having birefringence with the refractive index controlled in the thickness direction that has been monoaxially stretched in the plane direction and also stretched in the thickness direction or a tilted orientation film is used. Examples of tilted orientation film are those obtained by bonding a heat-shrinking film on a polymer film and performing a stretching process and/or a shrinking process on the polymer film under the action of the shrinking force thereof caused by the heating, or those obtained by oblique orientation of a liquid crystal polymer. The source material polymer of the retardation plate may be one similar to the polymer described in the previous retardation plate, and a suitable source material polymer intended for a purpose such as preventing the coloring or the like caused by change in the viewing angle based on the retardation due to the liquid crystal cell or enlarging the viewing angle can be used.

Also, in view of achieving a wide viewing angle having a good visibility, an optical compensating retardation plate in which an optically anisotropic layer made of an oriented layer of a liquid crystal polymer, particularly a tilted orientation layer of a discotic liquid crystal polymer, is supported by a triacetylcellulose film is preferably used.

A polarizing plate obtained by bonding a polarizing plate with a brightness-improving film is typically used by being disposed on the back side of a liquid crystal cell. The brightness-improving film is a film exhibiting a property of reflecting the linearly polarized light of a predetermined polarization axis or a circularly polarized light of a predetermined direction and transmitting the other light when natural light is incident by a back light unit of a liquid crystal display device or the like or reflection from the back side. The polarizing plate obtained by lamination of a brightness-improving film with a polarizing plate allows light from a light source such as a back light unit to be incident so as to obtain a transmitted light of a predetermined polarization state, and the light other than those in the predetermined polarization state is reflected without being transmitted. The light reflected on this brightness-improving film surface is allowed to be incident again into the brightness-improving film by reversing the light via a reflection layer or the like disposed further in the rear, and a part or a whole thereof is transmitted as the light in the predetermined polarization state, so as to increase the amount of the light that is transmitted through the brightness-improving film, and the polarized light that can be hardly absorbed by the polarizer is supplied so as to increase the amount of light usable for liquid crystal display image display or the like, whereby the brightness can be improved. Namely, in the event that the light is made to be incident through the polarizer from the back side of the liquid crystal cell by a back light unit or the like without using the brightness-improving film, most of the light having a polarization direction that is not coincident with the polarization axis of the polarizer will be absorbed by the polarizer and will not be transmitted through the polarizer. Namely, though differing in accordance with the characteristics of the polarizer to be used, about 50% of the light is absorbed by the polarizer, so that the amount of light that can be used for liquid crystal image display or the like will decrease for that amount, and the images will be dark. The brightness-improving film repeats the process of temporarily reflecting the light having a polarization direction that is liable to be absorbed by the polarizer without allowing the light to be incident into the polarizer and further reflecting the light via a reflection layer or the like disposed further in the rear so as to allow the light to be incident again into the brightness-improving film. Therefore, the brightness-improving film transmits only the light in which the polarization direction of the light that is reflected and reversed between these two has become a polarization direction capable of passing the polarizer, so as to supply the light to the polarizer, whereby the light of the back light unit or the like can be efficiently used for displaying images of the liquid crystal display device, and the screen can be made brighter.

A diffusing plate can be disposed between the brightness-improving film and the above-described reflection layer. The light in the polarization state reflected by the brightness-improving film will proceed towards the above-described reflection layer, and the disposed diffusing layer diffuses the passing light uniformly and eliminates the polarization state so as to achieve a non-polarized state. Namely, the diffusing plate turns the polarized light into the original natural light state. The light in this non-polarized state, namely, the natural light state, repeats the process of proceeding towards the reflection layer or the like, being reflected via the reflection layer or the like, passing through the diffusing plate, and being incident again into the brightness-improving film. By disposing a diffusing plate that turns the polarized light into the original natural light state between the brightness-improving plate and the above-described reflection layer in this manner, the unevenness of the brightness of the display screen can be reduced while maintaining the brightness of the display screen, whereby a uniform and bright screen can be provided. By disposing such a diffusing plate, it seems that the number of repetition of the reflection of the initial light increases to a good amount and, in combination with the diffusing function of the diffusing plate, a uniform and bright screen can be provided.

As the above-described brightness-improving plate, suitable brightness-improving plates such as those exhibiting a property of transmitting the linearly polarized light of a predetermined polarization axis and reflecting the other light such as a multiple-layer thin film of dielectrics or a thin film having a different refractive index anisotropy, or those exhibiting a property of reflecting the circularly polarized light of either one of rightward rotation or leftward rotation and transmitting the other light such as one in which an oriented film of cholesteric liquid crystal polymer or an oriented liquid crystal layer thereof is supported on a film base material.

Therefore, in a type of the above-described brightness-improving film that transmits the linearly polarized light of a predetermined polarization axis, by allowing the transmitted light to be incident as it is into the polarizing plate while arranging the polarization axis, the light can be transmitted efficiently while restraining the absorption loss caused by the polarizing plate. On the other hand, in the brightness-improving film of a type that transmits the circularly polarized light such as a cholesteric liquid crystal layer, the light can be allowed to be incident as it is into the polarizer; however, in view of restraining the absorption loss, the circularly polarized light is preferably allowed to be incident into the polarizer after being converted into linearly polarized light via a retardation plate. Herein, by using a ¼ wavelength plate as the retardation plate, the circularly polarized light can be converted into linearly polarized light.

The retardation plate functioning as the ¼ wavelength plate in a wide wavelength range such as a visible light band can be obtained, for example, by a method of superposing a retardation plate functioning as a ¼ wavelength plate to faint color light of a wavelength of 550 nm and a retardation plate exhibiting a different retardation property, for example, a retardation plate functioning as the ½ wavelength plate. Therefore, the retardation plate to be placed between the polarizing plate and the brightness-improving plate may be made of retardation layers of one layer or two or more layers.

Further, regarding the cholesteric liquid crystal layer, by making a combination of those differing in the reflection wavelength to provide a placement structure in which two or three or more layers are superposed, one can obtain those that reflect circularly polarized light in a wide wavelength range such as a visible light band and, on the basis thereof, a transmitted circularly polarized light in a wide wavelength range can be obtained.

Also, the optical film product (for example, a polarizing plate) of the present invention may be made of a lamination of a polarizing plate and optical layers of two layers or three or more layers, such as the above-described polarization separating type polarizing plate. Therefore, it may be a reflection-type elliptic polarizing plate or a semitransmitting type elliptic polarizing plate in which the above-described reflection-type polarizing plate or semitransmitting-type polarizing plate is combined with a retardation plate.

An optical film product in which the above-described optical layer is laminated on a polarizing plate can be formed by a method of sequentially separately laminating in a production process of the liquid crystal display device; however, an optical film made by lamination in advance is excellent in the stability of the product quality and the assembling work, thereby providing an advantage of improving the production process of the liquid crystal display device. For the lamination, a suitable bonding means such as an adhesive layer can be used. In bonding the above-described polarizing plate with the other optical layers, the optical axes thereof can be in a suitable placement angle in accordance with the retardation property or the like.

In the optical film product (polarizing plate) according to the present invention or the above-described laminated optical members, an adhesive layer for bonding to another member such as a liquid crystal cell is disposed. The adhesive layer is not particularly limited; however, it can be formed with a suitable adhesive agent that accords to the prior art such as an acryl-based adhesive agent. It is preferably an adhesive layer having a low moisture-absorbing property and being excellent in the heat resistance in view of preventing the foaming phenomenon caused by absorption of moisture or a peeling-off phenomenon, preventing decrease in the optical characteristics or warpage of the liquid crystal cell caused by thermal expansion difference or the like, and further a property of forming an image displaying apparatus having a high product quality and being excellent in durability. Also, the adhesive layer may be made to exhibit a light-diffusing property by containing fine particles. The adhesive layer may be disposed on a needed surface in accordance with the needs. For example, referring to a polarizing plate made of a polarizer and a polarizer protective layer, the adhesive layer may be disposed on one surface or on both surfaces of the polarizer protective layer in accordance with the needs.

Here, in the present invention, each layer of the polarizer, the polarizer protective film, or the optical film that form the above-described polarizing plate, as well as the adhesive layer, may be made to have, for example, an ultraviolet-absorbing property by a method such as treating with an ultraviolet absorber such as a salicylate-based compound, a benzophenol-based compound, benzotriazol-based compound, cyanoacrylate-based compound, or a nickel-complex- salt-based compound.

The optical film product of the present invention can be preferably used for forming an image displaying apparatus (corresponding to an optical display device) such as a liquid crystal display device, an organic EL display device, or a PDP.

The optical film product of the present invention can also be preferably used for forming various apparatus such as a liquid crystal display device. The liquid crystal display device can be formed according to the prior art. Namely, a liquid crystal display device is typically formed by suitably assembling construction components such as a liquid crystal cell (corresponding to an optical display unit), a polarizing plate or an optical film, and an illumination system or the like in accordance with the needs, followed by incorporating a driving circuit. In the present invention, there is no particular limitation except that the polarizing plate or the optical film of the present invention is used, so that it can be carried out according to the prior art. Regarding the liquid crystal cell also, those of any type such as a TN type, an STN type, or a π type can be used, for example.

A suitable liquid crystal display device can be formed such as a liquid crystal display device in which the polarizing plate or the optical film is disposed on one side or on both sides of the liquid crystal cell, or a liquid crystal display device in which a back light unit or a reflection plate is used in an illumination system. In that case, the polarizing plate or the optical film of the present invention can be disposed on one side or on both sides of the liquid crystal cell. In the event that the polarizing plate or the optical film is disposed on both sides, they may be the same or different. Further, in forming the liquid crystal display device, for example, suitable components such as a diffusing plate, an antiglaring layer, a reflection preventive film, a protective plate, a prism array, a lens array sheet, a light-diffusing plate, or a back light unit can be disposed as one layer or as two or more layers at a suitable position.

The optical film product (for example, a polarizing plate) according to the present invention can be preferably used for forming various apparatus such as a liquid crystal display device. The liquid crystal display device can be formed to have a suitable structure according to the prior art of transmittance type, a reflection type, or a combined type of transmittance and reflection in which the sheet-shaped product (for example, a polarizing plate) according to the present invention is disposed on one side or on both sides of the liquid crystal cell. Therefore, the liquid crystal cell that constitutes the liquid crystal display device is arbitrary and, for example, it may be one that uses a liquid crystal cell of a suitable type such as a simple matrix driving type represented by a thin film transistor type, for example.

Also, in the event that the polarizing plate or the optical member is disposed on both sides of the liquid crystal cell, they may be the same or different. Further, in forming the liquid crystal display device, for example, suitable components such as a prism array sheet, a lens array sheet, a light-diffusing plate, or a back light unit can be disposed as one layer or as two or more layers at a suitable position.

The invention has been described with examples where the optical film layer is a polarizing plate. Such examples are not intended to limit the scope of the invention, and the invention may also be applied to cases where the optical film is a laminate of a polarizing plate and a retardation plate or only a retardation plate

### EXAMPLE

In Example, an optical film product serving as a polarizing plate as shown in FIG. 1 was prepared according to the production method described above (the processes A to E) and cut into pieces of 6 inches in diagonal length. The fluorescent material-containing paint used was a fluorescent ink medium manufactured by Dainippon Ink and Chemicals, Incorporated. The thickness of the surface protection film was set at 100 μm. The average thickness of the weak pressure-sensitive adhesive layer was set at 6 μm. The thickness of the part having the printed optical axis information part was set at 0.01 μm. The optical axis information part was a triangle as shown in FIG. 2A, and a plurality of triangles were printed at regular intervals. The optical axis information part was substantially transparent as a whole but detectable by appearance inspection and was more easily recognized by black light irradiation.

### Comparative Example

In Comparative Example, an optical film product serving as a polarizing plate as shown in FIG. 1 was prepared and cut into pieces of 6 inches in diagonal length using the process of the above Example, except that the surface protection film was attached to the polarizing plate such that the printed optical axis information part was placed outside. The optical axis information part was formed in a slightly white color (or opaque like ground glass) on the outer surface of the surface protection film and thus detectable by appearance inspection and was more easily recognized by black light irradiation.

### Evaluation

The optical film products obtained in the Example and the Comparative Example were subjected to a defect inspection in which 10 appearance inspectors each inspected 5 optical film products. The optical film products used in the inspection randomly had defects under the optical axis information in such a manner that 5 optical film products had 15 defects in total. The inspectors did not know the total number of the defects under the optical axis information, when defect detection rate comparisons were performed. The results are shown in Table 1 in which the defect detection rate is the ratio of the number of the detected defects to that of the defects. In the inspection with the Example, the 10 inspectors each found the 15 defects under the optical axis information (the defect detection rate was 100%), and, therefore, the miss rate was 0%. In the inspection with the Comparative Example, only one inspector achieved a defect detection rate of 100%, and other 9 inspectors missed at least one defect and up to 4 defects.

TABLE 1

| | Example | | Comparative Example | |
|---|---|---|---|---|
| | | Miss | | Miss |
| Inspector | Defect detection Rate | Rate | Defect detection Rate | Rate |
| 1 | 100% (15 defects) | 0% | 80% (12 defects) | 20% |
| 2 | 100% (15 defects) | 0% | 100% (15 defects) | 0% |
| 3 | 100% (15 defects) | 0% | 93% (14 defects) | 7% |
| 4 | 100% (15 defects) | 0% | 80% (12 defects) | 20% |
| 5 | 100% (15 defects) | 0% | 80% (12 defects) | 20% |
| 6 | 100% (15 defects) | 0% | 87% (13 defects) | 13% |
| 7 | 100% (15 defects) | 0% | 93% (14 defects) | 7% |
| 8 | 100% (15 defects) | 0% | 93% (14 defects) | 7% |
| 9 | 100% (15 defects) | 0% | 73% (11 defects) | 27% |
| 10 | 100% (15 defects) | 0% | 80% (12 defects) | 20% |

(The inspectors were qualified according to the company standard.)

As apparent from the results of the inspection with the Example and the Comparative Example, the defects were surely detected in the Example with the optical axis information part formed between the surface protection film and the polarizing plate, while some defects were missed in the Comparative Example due to interference from the optical axis information part formed on the outer surface of the surface protection film. Therefore, the Example of the invention ensures the visual recognition of the optical axis information from the outside and also ensures the detection of defects in high-precision defect inspections.

What is claimed is:

1. An optical film product, comprising:
an optical film layer having an optical axis;
a surface protection film that is laminated on the optical film layer to protect a surface of the optical film layer; and
an optical axis information part that shows information about the optical axis is interposed between the optical film layer and the surface protection film.

2. The optical film product according to claim 1, wherein the optical axis information part is formed on the surface protection film by printing with a fluorescent material-containing paint.

3. A method for producing an optical film product including an optical film layer having an optical axis and a surface protection film that is laminated on the optical film layer to protect a surface of the optical film layer, comprising at least the steps of:
printing optical axis information part about the optical axis on the surface protection film; and
attaching the optical film layer and the surface protection film with the printed optical axis information part, while interposing the optical axis information part between the surface protection film and the optical film layer.

4. The method according to claim 3, wherein the optical axis information part is printed with a fluorescent material-containing paint on the surface protection film.
